(19) United States
(12) Patent Application Publication
(10) Pub. No.: US 2016/0023420 A1
(43) Pub. Date: Jan. 28, 2016

(54) Sheet feeding in box making machines

(71) Applicants: Michael P. Loos, Seven Valleys, PA (US); John W. Rogers, Red Lion, PA (US); Jeffrey D. Thomas, Westminster, MD (US); Craig Propert, Glen Burnie, MD (US)

(72) Inventors: Michael P. Loos, Seven Valleys, PA (US); John W. Rogers, Red Lion, PA (US); Jeffrey D. Thomas, Westminster, MD (US); Craig Propert, Glen Burnie, MD (US)

(21) Appl. No.: 14/121,051

(22) Filed: Jul. 25, 2014

(51) Int. Cl. B31B 1/12; B65H 3/08

(52) U.S. Cl. CPC B31B 1/12; B65H 3/08

(57) ABSTRACT

Plastic sheets are fed along a horizontal path from the bottom of a stack to a box making machine by a conveyor. The rear end of the stack rests on a metering bar located above the path at the rear end of the stack so that when the lowermost sheet is fed by the conveyor, its rear end drops and air jets from an air knife are introduced in the space between the stack and the lowermost sheet at the rear end of the stack to overcome friction forces and separate the lower most sheet from the stack as the sheet is conveyed along the path.

The present invention relates to improvements in feeding sheets, and more specifically to novel methods and apparatus for feeding sheets in the art of box making.

### BACKGROUND OF THE INVENTION

In the art of box making sheets of corrugated board are individually conveyed in a timed manner at high speed along a path to several stations where each board for example is slit and/or slotted and/or creased, and printed. The boards are individually fed to the processing conveyor from a stack of boards by a feeder for example disclosed in U.S. Pat. No. 6,824,130 Bland 7,635,124 B2 whose disclosures are hereby incorporated by reference into the subject application as part hereof.

A new concept has recently emerged in the box making industry which is the use of a plastic sheet rather than corrugated board to form the box. However, one of the most difficult applications for high speed sheet feeding is plastic. The weight and static friction that is associated with this medium causes difficulty in separating the sheets to allow them to feed individually. Tests of this new concept in box making apparatus have shown that the weight of the plastic sheet stack and the static friction between the sheets causes difficulty in separating the sheets to allow them to be fed individually especially when the width of the sheets is much smaller than the length. The result can cause jamming of the sheets and disruption of production keeping in mind that the sheets are required to move at a high speed and in timed manner.

It is well known in the art of paper copiers to use air flow such as “air knifes” to separate sheets from a stack for conveying the sheets such as disclosed for example in U.S. Pat. Nos. 4,163,277, 5,048,813, and 5,275,393. However, in the art of box making from corrugated boards, separation of the corrugated boards in typical operations has not posed a problem due to the lighter nature, air permeable, and lower friction material of the corrugated boards. To overcome the above noted problem, when plastic sheets are processed in box making machines, the present invention uniquely adapts an air knife as will be described below.

### SUMMARY OF PREFERRED EMBODIMENT OF THE INVENTION

The method and apparatus of the present invention include a feeder conveyor for individually feeding the lowermost sheet along a horizontal path from a stack of plastic sheets to the inlet of a box making machine. The sheet stack rests on a support which is termed a “metering bar”. The latter is positioned above the conveyor path but below the rear end portion of the stack. Once the conveyor moves the lowermost sheet off the metering bar, the rear end portion of the lowermost sheet drops by gravity creating a space between it and the above sheet into which space air flow is injected from an air knife at the rear end of the stack to overcome the frictional forces and allow separation of the lowermost sheet by the conveyor. The sheets are made from any suitable plastic, for example, urethane, and the air pressure can range from 15 to 80 psi depending on the sheet size and the height of the sheet stack.

### BRIEF DESCRIPTION OF THE DRAWINGS

The present invention will become more apparent from the detailed description below taken in conjunction with the accompanying drawings in which;

FIG. 1 is a side elevational view of a box making machine incorporating a sheet feeder constituting a preferred embodiment of the present invention;

FIG. 2 is a side elevational view of the sheet feeder shown in FIG. 1 but to an enlarged scale; and

FIG. 3 is a fragmental, perspective view of portions of the feeder and also showing a stack of sheets resting on a metering bar, and an air knife for directing air at the rear end portion of the stack to separate the lowermost sheet from the stack.

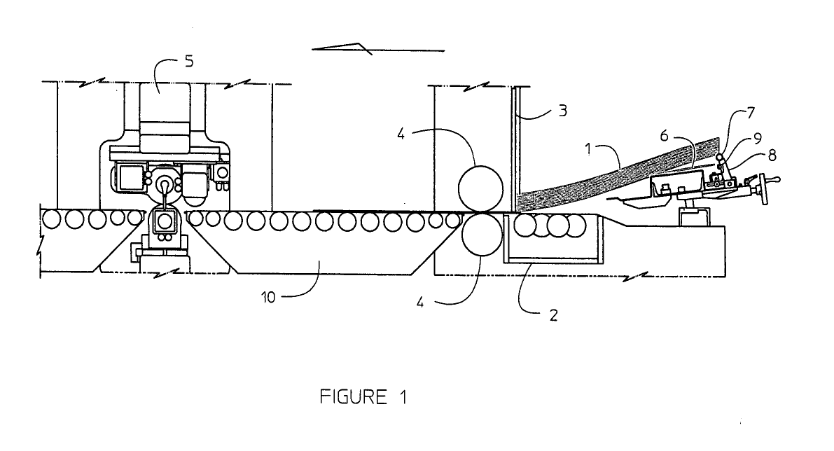

### DETAILED DESCRIPTION OF THE INVENTION

Referring to the drawings in detail there is shown for illustrative purposes only box making apparatus embodying the present invention for processing plastic sheets from a stack 1, whose underlying sheets 6 are individually fed by a timed feeder conveyor 2 below a gate 3 to pull rolls 4 which in turn feed the sheet to a processing conveyor 10. The latter moves the sheet along a horizontal path to one or more downstream processing stations where the sheet may be, for example, slotted, creased, scored, or printed. One such station is shown at 5.

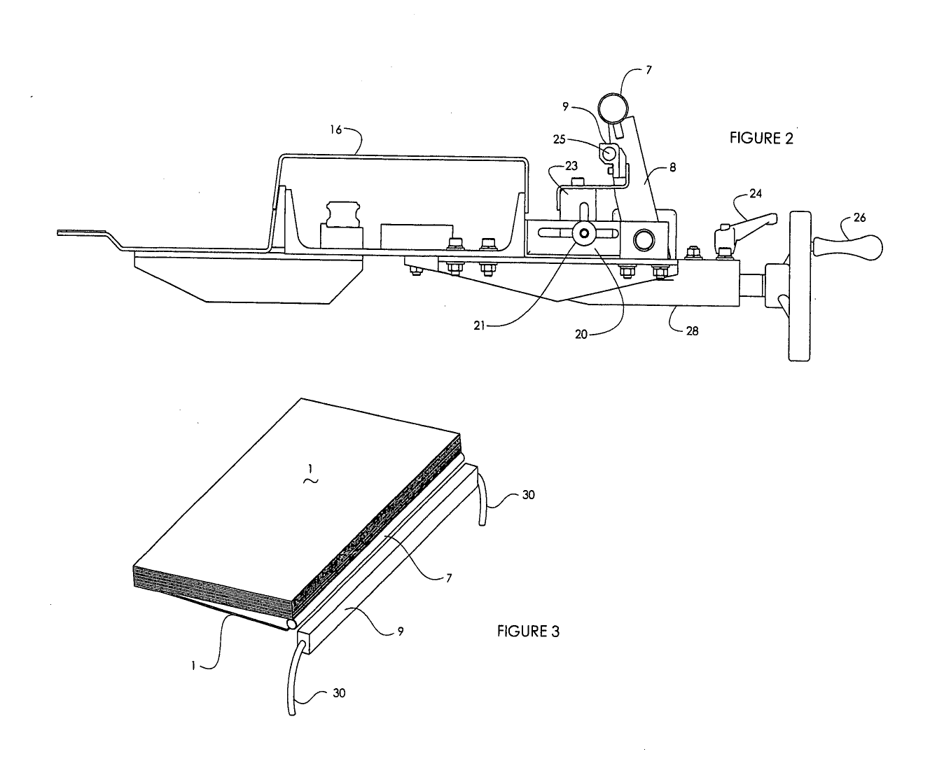

Referring to FIGS. 2 and 3, the stack of sheets rest on a metering bar 7 which extends transversely above the conveyance path under a rear end of the stack which is supported by the metering bar. The stack also rests on a stop bar 16. The metering bar 7 is mounted on a pivotable arm 8 for movement about a horizontal pivot axis towards or away from the sheet stack to adjust the position of the bar 7 to suit the size of the sheets. Once adjusted using a hand-wheel 26, the bar 7 and arm 8 are locked in position by a lock mechanism 24.

Extending transversely of the path of the conveyance and positioned below the metering bar 7 is an elongated air knife 9 for directing jets of air into the space between the lowermost sheet 6 in the stack and its overlying sheet 6, once the conveyor 2 moves the lowermost sheet 6 forwardly off the metering bar 7. Air under pressure is introduced from hoses 30 into ports 25 in the opposite ends of the air knife 9 which has outlet ports or nozzles on its front face for directing the air jets between the sheets as described above. Adjustment of the angle and position of the air flow is accomplished by the mounting brackets 20 and 23 which have vertical and horizontal slots for moving the air knife along these slots into desired vertical and horizontal positions.

Summarizing operation of the apparatus, the lowermost sheet 6 moves forward to the pull rolls 4 by the normal action of the feeder 2. This action “meters” the sheet allowing one sheet to drop from bar 7 by the force of gravity. The dropped sheet then provides a space or a gap where air is injected to reduce the frictional forces between the sheets. This reduction of forces allows the sheet 6 to be fed without jams. The air injection in the space at the rear of the sheet in accordance with the present invention, reduces the force through two phenomena:
(1) by injecting air which acts as a cushion for the sheet to allow its separation and
(2) by reducing the contact area of the sheet thereby reducing the friction and overall separation force requirement as it is being conveyed by feeder 20.

The sheet is also supported by the top of the back stop 16. The metering bar 7 allows a single sheet to drop by the force of gravity when pulled slightly forward by the feeder 2. Fine adjustment of the metering bar position is accomplished by rotating the support arm 8 with the use of the hand wheel 26.

The air pressure required to allow jam-free feeding of sheets will vary between 15-80 psi. depending upon the size of the sheet and the weight of the sheet stack. The sheets have high frictional forces and are significantly heavier than common corrugated board sheets. This combined with the fact that the plastic medium is not air permeable can make initial separation of the sheets quite difficult but for the present invention. The height of the stack in the feeder adds to the difficulty by increasing the overall downward force on the sheets. It should be understood that although the air knife itself is a conventional product available on the market, its particular use and positioning together with a metering bar in box making apparatus as shown and described herein, is believed to be unique especially when processing plastic sheets to be made into boxes.

Although preferred forms of the method and apparatus of the present invention have been disclosed in this application, other forms of the invention will become apparent to those skilled in the art but without departing from the invention as defined in the appended claims.

What is claimed is:

1. Sheet feeding apparatus for feeding sheets along a path from the bottom of a stack of sheets comprising in combination, a conveyor means for moving sheets from the bottom of a stack of sheets, a support means under the stack and above said path for engaging the lowermost sheet, said conveyor means being engageable with the lowermost sheet to move it off said support means and along said path, and air flow means for directing a flow of air between the lowermost sheet and the stack to separate the lowermost sheet from the stack, said support means being located to engage a rear end portion of said stack, and said air flow means being located to direct a flow of air at the rear end of the stack of sheets in a space located between the lowermost sheet and its overlying sheet once said conveyor moves the lowermost sheet off said support means.

2. Apparatus defined in claim 1 wherein said sheets are plastic sheets.

3. Apparatus defined in claim 1 further including a box making machine located downstream of the path for receiving the sheets from said conveyor means.

4. Apparatus defined in claim 2 further including a box making machine located downstream of the path for receiving the sheets from said conveyor means.

5. Apparatus defined in claim 2 wherein air flow is under a pressure of 15 to 80 psi.

6. Apparatus defined in claim 1 wherein said support is a cross bar under said rear end portion of the stack and extending transversely of and above said path.

7. Apparatus defined in claim 6 including means mounting said cross bar for movement towards or away from said rear end portion of the stack for adjustment.

8. A method of feeding sheets forwardly along a path from the bottom of a stack of sheets including the steps of placing the stack on a support positioned above said path and engaging the lowermost sheet at a rear portion of the stack, moving the lowermost sheet along the path and off the support so that the rear portion of the lowermost sheet drops to provide a space between the lowermost sheet and the stack, and directing a flow of air into said space at the rear portion of the stack between the lowermost sheet and the stack to separate the lowermost sheet from the stack as the lowermost sheet is moved along said path.

9. The method defined in claim 8 applied to feeding sheets to a box making machine.

10. The method defined in claim 8 wherein the sheets are plastic sheets.

11. The method defined in claim 10 applied to feeding plastic sheets to a box making machine.

12. The method defined in claim 8 wherein said support is an elongated member.
